(19) United States
(12) Patent Application Publication
(10) Pub. No.: US 2013/0266759 A1
(43) Pub. Date: Oct. 10, 2013

(54) FLOORING MATERIAL INCLUDING A PLA SURFACE LAYER HAVING WOOD PATTERNS

(71) Applicants: Jee-Woong Kim, Cheongju-si (KR); Gyu-Yull Kim, Cheongju-si (KR)

(72) Inventors: Jee-Woong Kim, Cheongju-si (KR); Gyu-Yull Kim, Cheongju-si (KR)

(73) Assignee: LG Hausys, Ltd., Yeongdeungpo-gu, Seoul (KR)

(21) Appl. No.: 13/993,932

(22) PCT Filed: Dec. 15, 2011
(86) PCT No.: PCT/KR2011/009645

§ 371 Date: Jun. 13, 2013

(30) Foreign Application Priority Data
Dec. 24, 2010 (KR) 10-2010-0134467

(51) Int. Cl. B32B 5/12

(52) U.S. Cl. CPC B32B 5/12
USPC 428/106

(57) ABSTRACT

The present invention relates to a flooring material including a PLA surface layer having a wood pattern. The flooring material includes a surface layer including at least one layer containing a PLA resin, a plywood layer including a veneer disposed on the undersurface of the surface layer, and a synthetic resin layer disposed on the undersurface of the plywood layer. The flooring material is cut in a tongue & groove shape.

### TECHNICAL FIELD

The present invention relate to a flooring material including a polylactic acid (PLA) surface layer having wood patterns, and more particularly, to a technology for forming a flooring material using an eco-friendly PLA resin.

### BACKGROUND ART

Flooring materials based on petroleum resins such as polyvinyl chloride (PVC) have mainly been used for buildings such as houses, apartments, offices, stores, and the like.

A polyvinyl chloride flooring material is manufactured through extrusion or calendering of resins, such as polyvinyl chloride. However, since polyvinyl chloride is a petroleum-based product, severe supply problems may be encountered due to petroleum depletion.

In addition, since polyvinyl chloride (PVC) flooring materials generate large amounts of toxic substances in use or disposal, it is necessary to suppress the use thereof as much as possible in view of environmental protection.

Therefore, in recent years, flooring materials based on eco-friendly resins have increasingly attracted attention as replacements for polyvinyl chloride flooring materials.

Besides, flooring materials in which a real sliced wood is adhered to a veneer sheet have been developed to emphasize natural appearance.

However, such natural flooring materials have insufficient strength, providing demerits in formation, cracking due to moisture infiltration, and gap widening upon heating.

### DISCLOSURE

### Technical Problem

An aspect of the present invention is to provide an eco-friendly flooring material, in which a print layer having a wood patterns is provided to a surface layer film comprising a PLA resin and the surface layer is coupled to a plywood layer and a synthetic resin layer, thereby providing good formability and resistance to submersion and cracking.

Another aspect of the present invention is to provide a flooring material, which may include a PLA surface layer having wood patterns to secure dimensional stability through a dimension-stabilizing layer having a glass fiber-impregnated structure upon heating, or may include wood flour, chaff, pine resin, and the like in a chip inlaid layer, thereby providing a natural texture which is difficult to realize in the related art.

A further aspect of the present invention is to provide a flooring material, which includes an upper layer formed of a veneer sheet and a PLA surface layer having wood patterns to provide a natural texture, and a base layer of a synthetic resin to which maifan stone, jade, or loess are added to provide various advantages in terms of user health by increasing far-infrared radiation and on which a separate sound blocking sheet layer for increasing a sound blocking effect is stacked to reduce floor impact sound.

### Technical Solution

In accordance with one aspect of the present invention, a flooring material including a polylactic acid (PLA) surface layer having wood patterns includes: a surface layer constituted by at least one layer comprised of a PLA resin and including a chip inlaid layer or print layer having wood patterns; a plywood layer formed under the surface layer and including veneer sheets; a synthetic resin layer formed under the plywood layer; and a surface treatment layer formed on the surface layer.

The plywood layer may be manufactured by thermally compressing at least three veneer sheets, and the veneer sheets may be alternately stacked one above another while being orthogonal to each other.

Next, the synthetic resin layer may be comprised of at least one selected from the group consisting of polylactic acid (PLA), polyethylene (PE), polypropylene (PP), polyvinyl chloride (PVC), rubber and polyurethane (PU).

Here, the synthetic resin layer may include 75 to 90 parts by weight of calcium carbonate and may further include 10 to 20 parts by weight of at least one of maifan stone, jade and loess, based on 100 parts by weight of the polyvinyl chloride.

The synthetic resin layer may include 35 to 40 parts by weight of calcium carbonate and 45 to 60 parts by weight of iron based on 100 parts by weight of the polyvinyl chloride.

The flooring material may be cut in a tongue & groove shape.

In accordance with another aspect of the present invention, a flooring material including a PLA (polylactic acid) surface layer having wood patterns includes: a surface layer including at least one layer having a printed wood pattern and comprised of a PLA (polylactic acid) resin; and a plywood layer and a synthetic resin layer formed under the surface layer.

In accordance with a further aspect of the present invention, a flooring material including a PLA surface layer of wood patterns includes a surface treatment layer, a transparent layer, a print layer having a wood pattern print, a bonding layer, a plywood layer and a synthetic resin layer from top of the flooring material, wherein at least one of the transparent layer and the print layer includes a PLA resin as a binder.

In accordance with yet another aspect of the present invention, a flooring material having a PLA surface layer of wood patterns includes a surface treatment layer, a transparent layer, a dimension-stabilizing layer having a wood pattern print, a bonding layer, a plywood layer and a synthetic resin layer from top of the flooring material, wherein at least one of the transparent layer and the print layer includes a PLA resin as a binder.

In accordance with yet another aspect of the present invention, a flooring material having a PLA surface layer of wood patterns includes a surface treatment layer, a chip inlaid layer of wood patterns, a bonding layer, a plywood layer and a synthetic resin layer from top of the flooring material, wherein the chip inlaid layer includes a PLA resin as a binder.

In accordance with yet another aspect of the present invention, a flooring material having a PLA surface layer of wood patterns includes a surface treatment layer, a chip inlaid layer having a wood pattern print, a bonding layer, a plywood layer and a synthetic resin layer from top of the flooring material, wherein the chip inlaid layer includes a PLA resin as a binder.

### Advantageous Effects

The present invention relates to a flooring material including a synthetic resin layer and a PLA surface layer having wood patterns, in which an upper layer includes a plywood layer of veneer sheets and a PLA surface layer having a print layer of wood patterns, and a lower layer includes sheets of a predetermined thickness prepared by shaping a synthetic resin into a plate shape through calendering and stacked one above another, thereby improving formability and resistance to water infiltration while providing a natural texture to the surface.

In addition, maifan stone, jade or loess powder may be added to the synthetic resin layer, thereby improving user health. Particularly, a sound blocking sheet layer is stacked on the synthetic resin layer, or otherwise, the synthetic resin layer is used as a sound blocking sheet, thereby reducing floor impact sound. Further, the synthetic resin layer has good thermal transfer capabilities as compared with wood, thereby blocking moisture while functioning as a piece of flat stone used for hypocaust flooring.

Further, the flooring material according to the present invention includes a polyvinyl chloride layer, thereby improving water resistance, shock absorbing performance, and far-infrared radiation capabilities above existing flooring materials. In addition, the flooring material according to the present invention is cut by a conventional cutting method, i.e., cut in a tongue & groove shape, so that a height difference between products due to an uneven floor can be solved, thereby facilitating application hypocaust floors.

Furthermore, according to one embodiment of the present invention, the flooring material has eco-friendliness and dimensional stability through a dimension-stabilizing layer of a glass fiber-impregnated structure upon heating, and includes wood flour, chaff, or pine resin to a chip inlaid layer, thereby providing a natural texture which is difficult to realize in the related art.

### DESCRIPTION OF DRAWINGS

FIG. 1 is a sectional view of a flooring material including a PLA surface layer having wood patterns according to a first embodiment of the present invention.

FIG. 2 is a sectional view of a flooring material including a PLA surface layer having wood patterns according to a second embodiment of the present invention.

FIG. 3 is a sectional view of a flooring material including a PLA surface layer having wood patterns according to a third embodiment of the present invention.

FIG. 4 is a sectional view of a flooring material including a PLA surface layer having wood patterns according to a fourth embodiment of the present invention.

FIG. 5 is a sectional view of a flooring material including a PLA surface layer having wood patterns according to a fifth embodiment of the present invention.

FIG. 6 is a sectional view of a flooring material including a PLA surface layer having wood patterns according to a sixth embodiment of the present invention.

FIG. 7 is a sectional view of a flooring material including a PLA surface layer having wood patterns, cut in a tongue & groove shape, according to an embodiment of the present invention.

### BEST MODE

The above and other aspects, features, and advantages of the invention will become apparent from the detailed description of the following embodiments in conjunction with the accompanying drawings. It should be understood that the present invention is not limited to the following embodiments and may be embodied in different ways, and that the embodiments are provided to provide complete disclosure of the invention and thorough understanding of the invention to those skilled in the art. The scope of the invention is defined only by the claims. Like components will be denoted by like reference numerals throughout the specification.

Now, a flooring material including a PLA surface layer having wood patterns according to embodiments of the present invention will be described in detail with reference to the accompanying drawings.

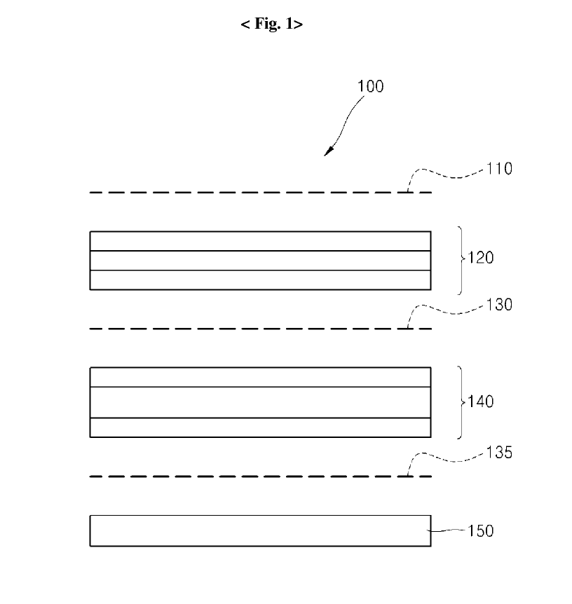

FIG. 1 is a sectional view of a flooring material 100 including a PLA surface layer having wood patterns according to a first embodiment of the present invention.

Referring to FIG. 1, the flooring material includes a surface treatment layer 110, a PLA surface layer 120 having a wood pattern print, a first bonding layer 130, a plywood layer 140, a second bonding layer 135, and a synthetic resin layer 150.

In the flooring material 100 having such a PLA surface layer, the plywood layer 140 is prepared by thermally compressing at least three veneer sheets, which are alternately stacked one above another while being orthogonal to each other.

Next, the synthetic resin layer 150 includes at least one selected from the group consisting of polylactic acid (PLA), polyethylene (PE), polypropylene (PP), polyvinyl chloride (PVC), rubber, and polyurethane (PU).

Here, the synthetic resin layer may include 75 to 90 parts by weight of calcium carbonate and may further include 10 to 20 parts by weight of at least one of maifan stone, jade and loess, based on 100 parts by weight of the polyvinyl chloride

Alternatively, the synthetic resin layer may include 35 to 40 parts by weight of calcium carbonate and 45 to 60 parts by weight of iron based on 100 parts by weight of the polyvinyl chloride

The polylactic acid (PLA) resin included in the surface layer 120 is a thermoplastic polyester of lactide or lactic acid, which can be prepared by polymerization of lactic acid obtained by fermentation of starch extracted from renewable plant resources, such as corn and potato. Such a PLA resin is an environmentally friendly material in that it discharges remarkably less toxic substances to the environment, for example, CO₂, in use or disposal than petroleum-based materials, for example, polyvinyl chloride (PVC), and thus has eco-friendly characteristics of ready biodegradation.

The PLA resin may be generally classified into D-PLA, L-PLA, D,L-PLA, meso-PLA, and the like. The PLA resin applied to flooring materials according to embodiments of the present invention may include any PLA resin used in the art, and may be used alone or in combination of two or more thereof.

As described above, the PLA resin may be prepared through polymerization of lactic acid or lactide, and, as needed, may be further copolymerized with a suitable copolymerizable component, which includes a glycol compound such as ethylene glycol or propylene glycol; dicarboxylic acid such as ethanedioic acid or terephthalic acid; hydroxycarbonic acid such as glycol acid and 2-hydroxy benzoic acid; lactones such as caprolactone or propiolactone, and the like.

In addition, according to the present invention, the PLA resin may be mixed with other resins such as a synthetic resin, and processing of the PLA resin may be carried out using the following plasticizers.

First, a non-phthalate plasticizer softens the PLA resin to improve thermoplasticity, thereby facilitating molding at high temperature. In one embodiment of the present invention, acetyl tributyl citrate (ATBC) may be used as the non-phthalate plasticizer.

Here, if the amount of the non-phthalate plasticizer is less than a reference amount based on 100 parts by weight of the PLA resin in the respective layers, hardness of the PLA resin can increase, thereby reducing processability. If the non-phthalate plasticizer is added in an amount exceeding the reference amount in the respective layers, compatibility with other components decreases, thereby deteriorating physical properties such as processibility.

Next, an acrylic copolymer may be used as a processing aid. Since the PLA resin has low melt strength or thermal resistance upon melt extrusion, the acrylic copolymer serves to improve melt strength of the PLA resin to secure processibility. Further, according to test results, the acrylic copolymer can be usefully applied to calendering and pressing of the PLA resin.

If the amount of the acrylic copolymer is less than a reference amount based on 100 parts by weight of the PLA resin, the PLA resin cannot secure sufficient improvement of melt efficiency and melt strength. If the amount of the acrylic copolymer exceeds the reference amount, manufacturing costs of the layers constituting the flooring material can increase and properties of the layers can be deteriorated due to low compatibility with other materials constituting the layers.

Although the weight average molecular weight of the acrylic copolymer is not particularly limited, the acrylic copolymer may have a weight average molecular weight ranging from 800,000 to 6,000,000 in consideration of improvement in melt strength and compatibility with other materials upon processing.

Next, the PLA resin may further include lubricants to prevent accumulation of deposits or crosslinked by-products during melt extrusion.

Lubricants make the surface of metal equipment, such as a calendar roller, smooth to improve fluidity in molding a resin composition of the present invention, prevent adhesion of a resin to the metal equipment, improve slippage, and adjust melt viscosity, thereby optimizing molding processability, particularly calendering processability.

Although there are various kinds of lubricants, environmentally friendly lubricants, for example, higher fatty acids, may be adopted in embodiments of the present invention. In particular, stearic acid corresponding to C₁₈ saturated high molecular weight fatty acid is used. These lubricants may be used alone or as mixtures thereof.

If the amount of the lubricant is less than a reference amount based on 100 parts by weight of the PLA resin, the effects of the lubricant cannot be obtained, and if the amount of the lubricant exceeds the reference amount based on 100 parts by weight of the PLA resin, the PLA resin can be deteriorated in impact resistance, heat resistance, and gloss.

In order to prevent the PLA resin from being deteriorated in mechanical properties such as impact resistance through hydrolysis of the PLA resin, the PLA resin may further include an anti-hydrolysis agent. Examples of the anti-hydrolysis agent may include carbodiimide and oxazoline.

If the amount of the anti-hydrolysis agent exceeds a reference amount based on 100 parts by weight of the PLA resin, forming processibility can be lowered.

As described above, the present invention is not limited to a method of manufacturing the PLA surface layer through calendering. For example, the method may include preparing a resin composition by mixing the aforementioned components, kneading and uniformly gelating the resin composition by heating and pressing the resin composition under suitable conditions, and calendering molding the resin composition into a final shape.

Here, mixing and kneading the components may be carried out, for example, on liquid or powdery raw materials using a super mixer, extruder, kneader, 2- or 3-roll. Further, the mixing and kneading processes may be repeatedly performed in stages so as to efficiently mix the components such that the mixed components are kneaded at about 120 to 200° C. using a Banbury mixer, and the kneaded components are subjected to primary mixing and secondary mixing at about 120° C. to about 200° C. using a 2-roll.

Also, there is no particular restriction as to a method of manufacturing each layer, which involves subjecting the mixed components to calendering. For example, each layer may be formed using a general device, for example, a 4-roll inverted “L” calendar.

Further, calendering conditions may be suitably adjusted in consideration of compositions of a used resin composition. For example, calendering may be carried out at a temperature ranging from about 120° C. to about 200° C.

After the PLA surface layer having wood patterns, the plywood layer of veneer sheets, and the synthetic resin layer are manufactured and integrated into a single body in the form of a half-finished product, a surface thereof is painted and then the base layer is cut to complete a finished good.

At this time, the flooring material according to the present invention may be manufactured by tongue & groove cutting as shown in FIG. 7.

According to the present invention, various embodiments of the flooring material are possible based on the foregoing configuration, and specific examples thereof are as follows.

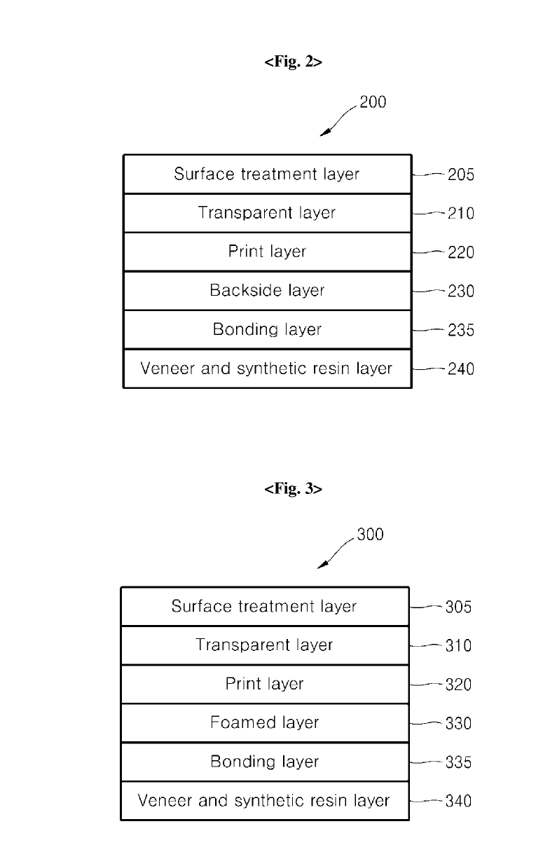

FIG. 2 is a sectional view of a flooring material 200 including a PLA surface layer having wood patterns according to a second embodiment of the present invention, and FIG. 3 is a sectional view of a flooring material 300 including a PLA surface layer having wood patterns according to a third embodiment of the present invention.

From above, FIG. 2 shows a surface treatment layer 205, and a backside layer 230 and a bonding layer 235 between a print layer 220 having a wood pattern print and a veneer/synthetic resin layer 240, and FIG. 3 shows a surface treatment layer 305, and a foamed layer 330 and a bonding layer 335 disposed between a print layer 320 having a wood pattern print and a veneer/synthetic resin layer 340.

At this time, the backside layer 230 and the foamed layer 330 may contain polylactic acid (PLA), detailed embodiments of which will be described below.

First, the transparent layers 110, 210, 310 may be commonly formed of a material including 5 to 50 parts by weight of a non-phthalate plasticizer and 0.1 to 20 parts by weight of processing aids, based on 100 parts by weight of the PLA resin.

Here, the transparent layers 110, 210, 310 may further include at least one of 0.01 to 10 parts by weight of higher fatty acid as a lubricant, 0.01 to 10 parts by weight of a chain extender, and 10 parts by weight or less of an anti-hydrolysis agent, based on 100 parts by weight of the PLA resin.

Next, the print layers 120, 220, 320 may be formed of a material including 5 to 60 parts by weight of a non-phthalate plasticizer and 0.1 to 20 parts by weight of processing aids, based on 100 parts by weight of the PLA resin.

Here, the print layers 120, 220, 320 may further include at least one of 0.01 to 10 parts by weight of higher fatty acid as a lubricant, 0.01 to 10 parts by weight of a chain extender, 10 parts by weight or less of an anti-hydrolysis agent, 100 parts by weight or less of calcium carbonate (CaCO₃), and 50 parts by weight or less of titanium dioxide (TiO₂), based on 100 parts by weight of the PLA resin.

Here, wood patterns may be printed by a printing method selected from among gravure printing, offset printing, rotary-screen printing, and inkjet printing.

Further, printing may be performed by a method selected from gravure printing, offset printing, rotary screen printing, and inkjet printing.

Here, a critical value of the amount of each component is based on the method of manufacturing the PLA layer of FIG. 1. If each component is added in an amount out of the above ranges, molding processability and combining strength with other components can decrease.

Next, the backside layer 230 may be referred to as a non-foamed layer, and include 5 to 60 parts by weight of a non-phthalate plasticizer, 0.1 to 20 parts by weight of an acrylic copolymer, 0.01 to 10 parts by weight of at least one of stearic acid and higher fatty acid as a lubricant, 10 parts by weight or less of an anti-hydrolysis agent, 200 parts by weight or less of at least one of wood flour and chaff, 300 parts by weight or less of CaCO₃, 5 parts by weight or less of TiO₂, and 20 parts by weight or less of pine resin, based on 100 parts by weight of the PLA resin.

Then, the foamed layer 330 may be formed in the same manner as the method of manufacturing the transparent layer, the print layer and the backside layer, except that a foaming agent is added.

However, the present invention is not limited to the foregoing methods and materials, and may employ any material based on methods using the PLA resin.

For example, the foamed layer may be prepared from a resin composition including 0.5 to 20 parts by weight of processing aids, 25 to 45 parts by weight of a plasticizer, and 5 to 60 parts by weight of a filler (for example, CaCO₃), based on 100 parts by weight of the PLA resin. In this case, the resin composition may include a suitable amount of a foaming agent for a foaming process.

According to another embodiment of the present invention, a chip inlaid layer or a printed chip inlaid layer may be formed instead of the foregoing print layer, and detailed shapes thereof are as follows.

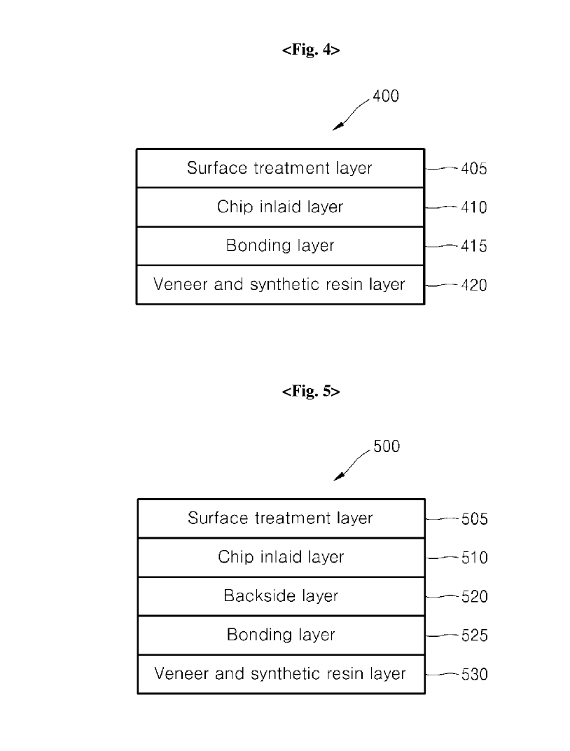

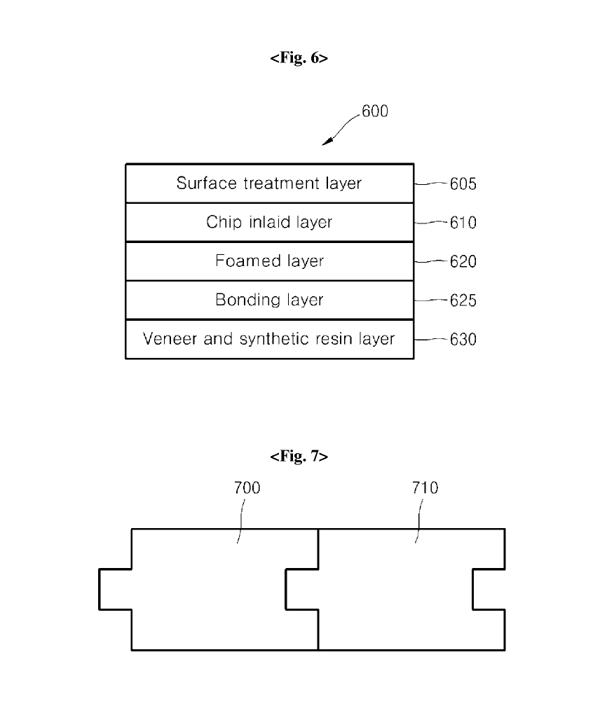

FIG. 4 is a sectional view of a flooring material 400 including a PLA surface layer having wood patterns according to a fourth embodiment of the present invention, FIG. 5 is a sectional view of a flooring material 500 including a PLA surface layer having wood patterns according to a fifth embodiment of the present invention, and FIG. 6 is a sectional view of a flooring material 600 including a PLA surface layer having wood patterns according to a sixth embodiment of the present invention.

First, referring to FIG. 4, the flooring material includes a surface treatment layer 405, a chip inlaid layer 410 having a wood pattern print, a bonding layer 415, and a veneer/synthetic resin layer 420 from top of the flooring material.

Next, referring to FIG. 5, the flooring material includes a surface treatment layer 505, a chip inlaid layer 510 having a wood pattern print, a backside layer 520, a bonding layer 525 and a veneer/synthetic resin layer 530 from the top of the flooring material, wherein the backside layer 520 is disposed between the chip inlaid layer 510 and the bonding layer 525. Here, a foamed layer (not shown) may be further formed on the backside layer 520.

Next, referring to FIG. 6, the flooring material includes a surface treatment layer 605, a chip inlaid layer 610 having a wood pattern print, a foamed layer 620, a bonding layer 625, a veneer/synthetic resin layer 630 from the top of the flooring material, wherein the foamed layer 620 is disposed on the bonding layer 625. Here, a foamed layer (not shown) may be further formed on the foamed layer 620.

The backside layer 520 is a non-foamed layer, on which a dimension-stabilizing layer may be further formed, and woven fabrics may be formed under the foamed layer 620.

Here, the woven fabrics may include T/C plain weave fabrics or knits. As yarns for the woven fabrics, 100% pure cotton, polyester, and polyester-nylon blended yarns may be used.

Hereinafter, the chip inlaid layers 410, 510, 610 will be described.

The chip inlaid layers 410, 510, 610 may have a chip shape with an appearance of natural wood patterns, and be formed in various shapes.

First, the chip inlaid layer may be prepared as follows. A PLA resin and wood flour are processed into a sheet-shaped product, which is then pulverized into chips. Then, the chips are provided to a raw material including a PLA resin, followed by calendering, thereby producing a sheet-shaped product.

Alternatively, the chip inlaid layers may be prepared by processing raw materials including a PLA resin and chip-like wood flour into a sheet-shaped product by calendering, instead of preparing separate chips. Thus, the chip inlaid layers may appear to have chips embedded therein, when viewed from the surface of a flooring material.

Alternatively, the chip inlaid layers may be prepared by processing a PLA resin and wood flour into a sheet-shaped product, which is then pulverized into chips, and the chips are arranged on a glass fiber impregnation layer and then subjected to rolling, or are arranged on a separate sheet of a PLA resin and then subjected to rolling.

To realize such configurations, in one embodiment, the chip inlaid layers 410, 510, 610 may further include at least one of acetyl tributyl citrate (ATBC) as a non-phthalate plasticizer, an acrylic copolymer as processing aids, and an anti-hydrolysis agent, in addition to the PLA resin.

The chip inlaid layer may include at least one of 5 to 100 parts by weight of a non-phthalate plasticizer, 0.1 to 20 parts by weight of an acrylic copolymer, 0.01 to 10 parts by weight of at least one of stearic acid and higher fatty acid as a lubricant, 10 parts by weight or less of an anti-hydrolysis agent, 200 parts by weight or less of at least one of wood flour and chaff, 500 parts by weight or less of CaCO₃, 50 parts by weight or less of TiO₂, and 20 parts by weight or less of pine resin, based on 100 parts by weight of the PLA resin.

Here, the acrylic copolymer may be used in the chip inlaid layer in an amount of 0.1 to 20 parts by weight based on 100 parts by weight of the PLA resin.

The lubricant may be used in the chip inlaid layer in an amount of 0.01 to 10 parts by weight based on 100 parts by weight of the PLA resin.

The anti-hydrolysis agent may be added to the chip inlaid layer in an amount of 10 parts by weight or less based on 100 parts by weight of the PLA resin.

Here, CaCO₃ functions as reinforcing inorganic fillers in the chip inlaid layer. Further, TiO₂ may be added as a white pigment for aesthetic purposes, and at least one of wood flour, chaff, or pine resin may be further added to impart the natural texture and smell of wood.

Here, the more wood flour, chaff, or pine resin is added, the more effective are visual impressions and the more natural are the texture and smell of wood. However, if the wood flour, the chaff, or the pine resin is added in an amount greater than the abovementioned range, combining strength of other components decreases, deteriorating overall processability of the PLA resin.

Although not shown, a transparent layer or a print layer containing the PLA resin may be further formed on the chip inlaid layer, and a backside layer (a non-foamed layer) and a foamed layer may also contain the PLA resin.

In addition, a surface treatment layer may be applied to the upper surface of the flooring material including the PLA surface layer having wood patterns, as shown in FIGS. 1 to 6, thereby improving surface qualities such as scratch resistance, wear resistance, and the like, or improving pollution resistance to facilitate cleaning. Here, the surface treatment layer may include materials containing polyurethane, polyurethane acrylate, or wax.

Furthermore, a dimension-stabilizing layer may be provided under the print layer or the chip inlaid layer to enhance dimensional stability of the flooring material.

The dimension-stabilizing layer according to the present invention serves to supplement the dimensional stability of the PLA resin. Flooring materials using a PLA resin encounter change in dimensions due to temperature change by heating, resulting in contraction, and accordingly cracks may occur in connected parts between flooring materials. Thus, the dimension-stabilizing layer is provided to secure dimensional stability, thus preventing the flooring materials from cracking.

The dimension-stabilizing layer according to the present invention has a glass fiber-impregnated structure. For example, an acrylic resin impregnated with glass fiber is used as the dimension-stabilizing layer.

Here, the glass fiber may have a mass per unit area of 30 g/m² to 150 g/m². If the mass per unit area of the glass fiber is less than 30 g/m², insufficient dimensional stability is obtained, and if the mass per unit area of the glass fiber exceeds 150 g/m², adhesion between the chip inlaid layer 110 and the dimension-stabilizing layer is lowered.

The dimensional stabilizing layer may further include at least one selected from the group consisting of ATBC as a plasticizer, a viscosity lowering agent, calcium carbonate as an inorganic filler for reducing production costs, titanium dioxide as a white pigment, and a combination thereof, in addition to the acrylic resin.

Here, ATBC may be added in an amount of 40 to 150 parts by weight based on 100 parts by weight of the acrylic resin, the viscosity lowering agent may be added in an amount of 30 parts by weight or less, calcium carbonate may be added in an amount of 150 parts by weight or less, and titanium dioxide may be added in an amount of 20 parts by weight or less.

If the amount of ATBC is less than 40 parts by weight based on 100 parts by weight of the acrylic resin, hardness of the dimensional stabilizing layer can increase, thereby reducing processability. If the amount of ATBC is greater than 150 parts by weight, dimensional stability can deteriorate due to inappropriate compatibility with other components.

If the amount of the viscosity lowering agent is greater than 30 parts by weight based on 100 parts by weight of the acrylic resin, viscosity excessively decreases, thereby deteriorating formability. If calcium carbonate and titanium dioxide are present above the above ranges, adhesion to other components may decrease, deteriorating processability.

Based on the foregoing features, the thickness of each layer may range as follows. The bonding layer may have a thickness of 0.01 to 0.5 mm; the transparent layer, 0.1 to 1 mm; the print layer may have a thickness of 0.05 to 0.5 mm; the inlaid layer may have a thickness of 0.3 to 3.0 mm; the backside layer may have a thickness 0.2 to 2.0 mm; the foamed layer may have a thickness 0.5 to 20.0 mm; the dimension-stabilizing layer may have a thickness of 0.1 to 1.0 mm; and the surface treatment layer may have a thickness of 0.01 to 0.1 mm.

If each layer has a thickness less than the set range, the complex material becomes too thin and thus does not exhibit desired properties. On the other hand, if each layer has a thickness greater than the set range, the complex material becomes too thick and thus cannot suitably function.

Hereinafter, the present invention will be described in detail with reference to some examples of a transparent layer, a print layer, a chip inlaid layer, a non-foamed layer, and a foamed layer, which are commonly applied to the foregoing embodiments. These examples are provided for illustration only and are not to be in any way construed as limiting the present invention. Therefore, descriptions of details apparent to those skilled in the art will be omitted herein.

### Preparative Examples

Preparation of Transparent Layer

100 parts by weight of PLA resin, 2002D (melt index: less than 3, NatureWorks LLC), 20 parts by weight of ATBC, 10 parts by weight of an acrylic copolymer, 5 parts by weight of stearic acid, and 5 parts by weight of a carbodiimide were kneaded first using an extruder, kneaded at 140° C. using a Banbury mixer, and then subjected to primary and secondary mixing using a 2-roll at 140° C. Then, the prepared raw material was subjected to calendering at 130° C., thereby producing a sheet having a thickness of about 0.6 mm.

Preparation of Print Layer

A 0.2 mm thick sheet was prepared in the same manner as in the preparation of the transparent layer except that 100 parts by weight of a PLA resin, 30 parts by weight of ATBC, 10 parts by weight of an acrylic copolymer, 5 parts by weight of stearic acid, 5 parts by weight of diisocyanate, 5 parts by weight of carbodiimide, 50 parts by weight of calcium carbonate, and 20 parts by weight of titanium dioxide were used.

The print layer was deposited on a dimension-stabilizing layer and subjected to thermal lamination at 150° C. to form a print layer-dimension-stabilizing layer, followed by forming a pattern on the surface of the print layer by gravure printing.

Preparation of Chip-Inlaid Layer

A sheet having a thickness of about 2.8 mm was prepared using 100 parts by weight of a PLA resin, 40 parts by weight of ATBC, 10 parts by weight of an acrylic copolymer, 5 parts by weight of stearic acid, 5 parts by weight of carbodiimide, 130 parts by weight of wood flour, 20 parts by weight of chaff, 280 parts by weight of calcium carbonate, 20 parts by weight of titanium dioxide, and 10 parts by weight of pine resin.

Preparation of Non-Foamed Layer

100 parts by weight of a PLA resin, 20 parts by weight of ATBC, 10 parts by weight of an acrylic copolymer, 5 parts by weight of stearic acid, 5 parts by weight of carbodiimide, 150 parts by weight of calcium carbonate, 130 parts by weight of wood flour, 30 parts by weight of chaff, 2 parts by weight of titanium dioxide, and 10 parts by weight of pine resin were first kneaded using an extruder, kneaded at 140° C. using a Banbury mixer, and then subjected to primary and secondary mixing using a 2-roll at 140° C. Then, the prepared raw material was subjected to calendering at 130° C., thereby producing a sheet having a thickness of about 1.4 mm.

Preparation of Dimension-Stabilizing Layer

An acrylic sol was prepared by mixing 100 parts by weight of an acrylic resin, 60 parts by weight of ATBC, 15 parts by weight of a viscosity lowering agent, 50 parts by weight of calcium carbonate, and 5 parts by weight of titanium dioxide. The acrylic sol was impregnated with glass fiber (60 g/m²) using a roll coater, followed by drying at 140° C. for 3 minutes, thereby obtaining a dimension-stabilizing layer having a thickness of about 0.6 mm.

Preparation of Surface Treatment Layer

The chip inlaid layer, the glass fiber-impregnated layer, and the non-foamed layer-rear fiber layer were subjected to thermal lamination using an embossing roll, and then, a surface treatment layer was formed to a thickness of about 0.05 mm on the surface of the chip inlaid layer using wax, thereby producing a final surface material. In this example, the transparent layer, the print layer, the chip inlaid layer, and the non-foamed layer were prepared based on the PLA resin

Preparation of Plywood Layer

A veneer plywood layer is formed using south sea wood (a broadleaf tree growing in the tropics) as hardwood for veneer sheets typically used in a flooring material. In this invention, dried hardwood having a water content of 12% or less is used when sliced into a predetermined thickness.

In this invention, plywood of veneer sheets may be prepared by stacking three or more veneer sheet of a predetermined size to be orthogonal to each other.

In this manner, the veneer sheets are orthogonally stacked one above another to provide a stable design according to variation and balance while securing stability with less dimensional variation.

Here, a 3-plywood may be prepared by processing and slicing hardwood into veneer sheets of a predetermined thickness, drying, and alternately stacking three sheets in different directions, in which a melamine or phenol resin adhesive may be used in order to secure water-proofing properties.

Herein, a plywood layer using a melamine adhesive will be described.

As used herein, a melamine resin generally has a solid content of 50 wt % or more, and 100 parts by weight of the melamine resin is mixed with 15˜20 parts by weight of flour and 1˜3 parts by weight of ammonium chloride as a curing agent to adjust viscosity for convenience.

More specifically, a melamine adhesive is deposited in an amount of 28˜30 g/ft² on both sides of a core veneer of 3 plies and compressed at 117˜123° C. for 50˜60 seconds under a force of 8˜12 kg/cm².

The 3 plies included a face veneer, a core veneer, and a back veneer. In this invention, in preparation of the plywood layer, the face veneer, the core veneer, and the back veneer are stacked in a thickness ratio of 0.75:1.5:0.75, followed sanding both sides to form a 2.7 mm thick plywood layer, or are stacked in a thickness ratio of 0.75:1.8:0.75, followed by sanding both sides to form a 3.0 mm thick plywood layer.

Alternatively, the face veneer, the core veneer, and the back veneer are stacked in a thickness ratio of 0.9:2.1:0.9, followed by sanding both sides to form a 3.6 mm thick plywood layer. In this way, the plywood layer having a thickness of 2.5˜4.0 mm is prepared in the aforementioned configuration and thickness ratio.

Preparation of Synthetic Resin Layer

The synthetic resin layer may be prepared using polylactic acid (PLA), polyethylene (PE), polypropylene (PP), polyvinyl chloride (PVC), rubber, polyurethane (PU), and the like.

Herein, a polyvinyl chloride layer will be described as the synthetic resin layer. In preparation of the polyvinyl chloride layer, 30˜35 parts by weight of dioctylphthalate as a plasticizer, 400˜550 parts by weight of calcium carbonate (specific weight: 2.5˜2.8) as an inorganic filler, and 5˜10 parts by weight of barium stearate as a stabilizer are added to 100 parts by weight of polyvinyl chloride having a degree of polymerization of 900˜1300, followed by sufficiently kneading at 160˜190° C. using a roller, rolling into a thickness of 2.0˜3 0 mm through a calendar, and cutting into a size of 920˜1000 mm length and 920˜1000 mm width. Then, the prepared polyvinyl chloride sheet is stacked under a veneer layer.

Here, calcium carbonate provided to the polyvinyl chloride sheet used as a base layer has a specific weight of 2.7 and is present in an amount of 75% in the polyvinyl chloride layer so as to provide a sufficient hypocaust flooring effect. Further, maifan stone, jade or loess powder added for improvement of user health may be present in an amount of 10˜20% based on the total amount of calcium carbonate, thereby providing desired functions.

Then, since bonding of the plywood layer and the synthetic resin layer is performed using different adhesives according to the kind of bonding process, it can be classified into hot press bonding and cold press bonding.

First, upon hot press bonding, a melamine adhesive used in preparation of the plywood layer is used as an adhesive with respect to the surface layer, and an adhesive for bonding the plywood layer to the synthetic resin layer is an epoxy adhesive, which is prepared by mixing an aliphatic amine, polyamide or polysulfide curing agent with a typical epoxy resin prepared through reaction of epichlorohydrin and bisphenol A. A mixture prepared by mixing 1 part by weight of the epoxy resin with 1 part by weight of the curing agent is deposited on the synthetic resin layer in an amount of 60˜130 g per unit area.

In this way, with the corresponding adhesives deposited on the plywood layer and the synthetic resin layer, the PLA surface layer having wood patterns, the plywood layer and the synthetic resin layer are sequentially stacked and subjected to hot pressing at 117˜123° C. under a pressure of 8˜12 kg/cm² for 2˜5 minutes while cooling the resultant to a surface temperature of 35° C., thereby preparing an integrated flooring material.

In cold press bonding, the plywood layer and the synthetic resin layer are primarily integrated using the aforementioned adhesives through hot pressing, and the wood pattern PLA surface layer is then stacked on a primary half-finished product, that is, on a surface of the plywood layer at room temperature after depositing an epoxy adhesive in an amount of 80˜150 g/m² and is integrated therewith by cold pressing under a pressure of 8˜12 kg/cm² for 1 hour, followed by being left in a room at 40˜60° C. for 4˜5 hours in order to achieve complete curing of the adhesives for subsequent processes.

### Example 1

After deposition of adhesives, a synthetic resin layer, a plywood layer, and a wood pattern PLA surface layer were stacked and integrated by cold pressing, followed by formation of a surface paint layer and cutting into a tongue & groove shape, thereby preparing a wood-patterned flooring material f.

In this example, the PLA surface layer has a thickness of 0.3˜3.0 mm, the plywood layer has a thickness of 4.2˜12.0 mm, and a polyvinyl chloride layer provided as the synthetic resin layer has a thickness of 1.2˜4 5 mm such that the flooring material has a total thickness of 7.0˜15 mm.

### Example 2

A flooring material was prepared in the same manner as in Example 1 except that the synthetic resin layer comprised 75 parts by weight of calcium carbonate based on 100 parts by weight of the polyvinyl chloride layer.

In addition, 10 parts by weight of jade or loess was further added based on 100 parts by weight of calcium carbonate.

### Example 3

A flooring material was prepared in the same manner as in Example 2 except that calcium carbonate was added in an amount of 35 parts by weight and iron was added in an amount of 90 parts by weight based on 100 parts by weight of the polyvinyl chloride layer.

### Comparative Example 1

A flooring material was prepared in the same manner as in Example 1 except that actual wood veneer was used instead of the wood pattern PLA surface layer.

TABLE 1
Results of physical property evaluation of flooring material

| | | | Moisture |
|---|---|---|---|
| | | Caster | infiltration |
| | Impact strength | resistance | resistance |
| Example 1 | 400 mm | Good | Good |
| Example 2 | 400 mm | Good | Good |
| Example 3 | 400 mm | Good | Good |
| Comparative Example 1 | 150 mm | Compressed | Surface |
| | | and Whitened | discoloration |
| | | | (Rotten) |

Here, the impact strength was determined by measuring a height at which a spherical weight of 286 g dropped on a surface of a flooring material resulted in fracturing thereof.

Referring to Table 1, it can be seen that the flooring materials of the inventive examples had superior impact strength to Comparative Example 1 since the impact strength, in terms of drop height, of the flooring materials of the inventive examples was 1.5 times that of the flooring material of the comparative example.

Next, the caster resistance was determined through visual inspection on the surface of the flooring material with the naked eye after reciprocating a 60 kg caster 1,000 times on the surface of the flooring material, and moisture infiltration resistance was determined through visual inspection of the surface of the flooring material with the naked eye after immersing a rear side of the flooring material into water for 1 day.

Referring to Table 1, the flooring material of Comparative Example 1 exhibited compression or whitening in terms of caster resistance and was vulnerable to moisture infiltration, whereas the flooring materials of the inventive examples provided good results.

As described above, in the flooring material having a PLA (polylactic acid) surface layer of wood patterns according to the present invention, a PLA resin (or a mixture of the PLA resin and other resins) is used as a binder in forming a surface layer, thereby exhibiting more eco-friendly properties than conventional surface layers containing a polyvinyl chloride binder. In addition, the flooring material according to the present invention includes a print layer, a chip inlaid layer, a dimension-stabilizing layer, a non-foamed layer, a foamed layer, and woven fabrics to secure sound-proofing performance, buffering effect, and heat insulation, and thus can be widely employed as a building material.

Although the present invention has been described with reference to some exemplary embodiments, it should be understood that these embodiments are given by way of illustration only and do not limit the scope of the invention, and that various modifications, variations, and alterations can be made by a person having ordinary knowledge in the art without departing from the spirit and scope of the invention. Therefore, the scope of the invention should be limited only by the accompanying claims and equivalents thereof.

1. A flooring material including a polylactic acid (PLA) surface layer having wood patterns, comprising:
a surface layer constituted by at least one layer comprised of a PLA resin and comprising a chip inlaid layer or print layer having wood patterns;
a plywood layer formed under the surface layer and comprising veneer sheets;
a synthetic resin layer formed under the plywood layer; and
a surface treatment layer formed on the surface layer.

2. The flooring material according to claim 1, wherein the plywood layer is manufactured by thermally compressing at least three veneer sheets.

3. The flooring material according to claim 2, wherein the veneer sheets are alternately stacked one above another to be orthogonal to each other.

4. The flooring material according to claim 1, wherein the synthetic resin layer comprises at least one selected from the group consisting of polylactic acid (PLA), polyethylene (PE), polypropylene (PP), polyvinyl chloride (PVC), rubber and polyurethane (PU).

5. (canceled)

6. (canceled)

7. The flooring material according to claim 4, wherein the synthetic resin layer comprises 35 to 40 parts by weight of calcium carbonate and 45 to 60 parts by weight of iron, based on 100 parts by weight of the polyvinyl chloride.

8. (canceled)

9. The flooring material according to claim 1, wherein the surface layer comprises at least one selected from among a transparent layer, a print layer having a print, a chip inlaid layer, a non-foamed layer, and a foamed layer.

10. The flooring material according to claim 9, wherein the surface layer further comprises a dimension-stabilizing layer under the print layer or under the chip inlaid layer.

11. The flooring material according to claim 10, wherein the dimension-stabilizing layer comprises glass fibers impregnated into at least one dimension-stabilizing binder resin selected from among an acrylic resin, a melamine resin and a PLA resin.

12. The flooring material according to claim 11, wherein the glass fibers have a mass per unit area of 30 g/m² to 150 g/m².

13. The flooring material according to claim 11, wherein the dimension-stabilizing layer further comprises at least one of 40 to 150 parts by weight of a non-phthalate plasticizer, 30 parts by weight or less of a viscosity lowering agent, 150 parts by weight or less of calcium carbonate, and 20 parts by weight or less of titanium dioxide, based on 100 parts by weight of the dimension-stabilizing binder resin.

14. The flooring material according to claim 9, wherein the transparent layer comprises 5 to 50 parts by weight of a non-phthalate plasticizer and 0.1 to 20 parts by weight of processing aids, based on 100 parts by weight of the PLA resin.

15. The flooring material according to claim 14, wherein the transparent layer further comprises at least one of 0.01 to 10 parts by weight of higher fatty acid as a lubricant, 0.01 to 10 parts by weight of a chain extender, and 10 parts by weight or less of an anti-hydrolysis agent, based on 100 parts by weight of the PLA resin.

16. The flooring material according to claim 9, wherein the print layer comprises 5 to 60 parts by weight of a non-phthalate plasticizer and 0.1 to 20 parts by weight of processing aids based on 100 parts by weight of the PLA resin.

17. The flooring material according to claim 16, wherein the print layer further comprises at least one of 0.01 to 10 parts by weight of higher fatty acid as a lubricant, 0.01 to 10 parts by weight of a chain extender, 10 parts by weight or less of an anti-hydrolysis agent, 100 parts by weight or less of calcium carbonate (CaCO₃), and 50 parts by weight or less of titanium dioxide (TiO₂), based on 100 parts by weight of the PLA resin.

18. The flooring material according to claim 9, wherein the chip inlaid layer further comprises at least one of a non-phthalate plasticizer, an acrylic copolymer as processing aids, and an anti-hydrolysis agent in addition to the PLA resin.

19. The flooring material according to claim 18, wherein the acrylic copolymer has a weight average molecular weight (Mw) of 800,000 to 6,000,000.

20. The flooring material according to claim 18, wherein the anti-hydrolysis agent comprises carbodiimide or oxazoline.

21. The flooring material according to claim 18, wherein the chip inlaid layer further comprises at least one of 5 to 100 parts by weight of the non-phthalate plasticizer, 0.1 to 20 parts by weight of the acrylic copolymer, 0.01 to 10 parts by weight of at least one of stearic acid and higher fatty acid as a lubricant, 10 parts by weight or less of the anti-hydrolysis agent, 200 parts by weight or less of at least one of wood flour and chaff, 500 parts by weight or less of calcium carbonate (CaCO₃), 50 parts by weight or less of titanium dioxide (TiO₂), and 20 parts by weight or less of pine resin, based on 100 parts by weight of the PLA resin.

22. The flooring material according to claim 9, wherein the non-foamed layer comprises at least one of 5 to 60 parts by weight of a non-phthalate plasticizer, 0.1 to 20 parts by weight of an acrylic copolymer, 0.01 to 10 parts by weight of at least one of stearic acid and higher fatty acid as a lubricant, 10 parts by weight or less of an anti-hydrolysis agent, 200 parts by weight or less of at least one of wood flour and chaff, 300 parts by weight or less of calcium carbonate, 5 parts by weight or less of titanium dioxide, and 20 parts by weight or less of pine resin, based on 100 parts by weight of the PLA resin.

23. The flooring material according to claim 1, wherein the surface treatment layer comprises at least one of polyurethane, polyurethane acrylate and wax.

24-40. (canceled)
